(19) United States
(12) Patent Application Publication
(10) Pub. No.: US 2025/0165273 A1
(43) Pub. Date: May 22, 2025

(54) INFORMATION INTERACTION

(71) Applicants: Beijing Zitiao Network Technology Co., Ltd., Beijing (CN); Lemon Inc., Grand Cayman (KY)

(72) Inventors: Lingyu WANG, Beijing (CN); Koken ISHII, Los Angeles, CA (US); Xin ZHONG, Beijing (CN); Yingdi SUN, Beijing (CN)

(21) Appl. No.: 18/949,558

(22) Filed: Nov. 15, 2024

(30) Foreign Application Priority Data
Nov. 20, 2023 (CN) 202311551049.1

(51) Int. Cl. G06F 9/451; G06F 3/0481; G06F 3/04842

(52) U.S. Cl. CPC G06F 9/453; G06F 3/0481; G06F 3/04842

(57) ABSTRACT

A method, an apparatus, a device and a storage medium are provided. In the method, in response to a predetermined operation associated with a conversation window of a user and a digital assistant, a first message from the digital assistant is presented in the conversation window. In the method, in the first message, an element related to one or more task components is presented. Each task component is configured to perform a corresponding function. The task component includes at least one of a plug-in or a scenario.

### CROSS-REFERENCE

This application claims priority to Chinese patent application No. 202311551049.1, filed on Nov. 20, 2023 and entitled ‘METHOD, APPARATUS, DEVICE AND STORAGE MEDIUM FOR INFORMATION INTERACTION’, which is incorporated herein by reference in its entirety.

### FIELD

Example embodiments of the present disclosure generally relate to the field of computers, and in particular, to information interaction.

### BACKGROUND

With the development of information technologies, various terminal devices may provide various services to people in terms of work and life. An application providing a service may be deployed in the terminal device. The terminal device or application may provide a digital assistant function to the user to assist the user in using the terminal device or application. How to improve the flexibility of interaction between a user and a digital assistant is a technical problem to be explored currently.

### SUMMARY

In a first aspect of the present disclosure, a method of information interaction is provided. In the method, in response to a predetermined operation associated with a conversation window of a user and a digital assistant, a first message from the digital assistant is presented in the conversation window. In the method, in the first message, an element related to one or more task components is presented. Each task component is configured to perform a corresponding function. The task component includes at least one of a plug-in or a scenario.

In a second aspect of the present disclosure, an electronic device is provided. The device includes: at least one processing unit; and at least one memory coupled to the at least one processing unit and storing instructions for execution by the at least one processing unit, the instructions, when executed by the at least one processing unit, causing the electronic device to perform the method of the first aspect.

In a third aspect of the present disclosure, a computer-readable storage medium is provided. The computer-readable storage medium having a computer program stored thereon, and the computer program being executable by a processor to perform the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIGS. 2A to 2F illustrate schematic diagrams of example interfaces according to some embodiments of the present disclosure;

FIG. 3 illustrates a flowchart of an example process for information interaction according to some embodiments of the present disclosure;

FIGS. 4A to 4D illustrate schematic diagrams of example interfaces according to some embodiments of the present disclosure;

FIG. 5 illustrates a flowchart of an example process for information interaction according to some embodiments of the present disclosure;

FIGS. 6A to 6C illustrate schematic diagrams of example interfaces according to some embodiments of the present disclosure;

FIG. 7 illustrates a flowchart of an example process for information interaction according to some embodiments of the present disclosure;

FIG. 8 illustrates a flowchart of an example process for information interaction according to some embodiments of the present disclosure;

FIG. 9 illustrates a schematic block diagram of an apparatus for information interaction according to some embodiments of the present disclosure; and

FIG. 10 illustrates a block diagram of an electronic device capable of implementing one or more embodiments of the present disclosure.

### DETAILED DESCRIPTION

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select ‘agree’ or ‘disagree’ to provide personal information to the electronic device.

It may be understood that the foregoing notification and obtaining a user authorization process is merely illustrative and does not constitute a limitation on implementations of the present disclosure. Other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

Herein, unless explicitly stated, ‘in response to A’ performs one step and does not imply that this step is performed immediately after ‘A’ but may include one or more intermediate steps.

In the description of the embodiments of the present disclosure, the terms ‘including’, and the like should be understood to include ‘including but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below. The terms ‘first,’ ‘second,’ and the like may refer to different or identical objects. Other explicit and implicit definitions may also be included below.

As used herein, the term ‘model’ may learn associations between respective inputs and outputs from training data such that corresponding outputs may be generated for a given input after training is complete. The generation of the model may be based on machine learning techniques. Deep learning is a machine learning algorithm that processes inputs and provides corresponding outputs with a multi-layer processing unit. ‘Model’ may also be referred to herein as a ‘machine learning model,’ ‘machine learning network,’ or ‘network,’ which terms are used interchangeably herein. A model may in turn include different types of processing units or networks.

As used herein, a ‘unit,’ an ‘operating unit,’ or a ‘subunit’ may be composed of a machine learning model or network of any suitable structure. As used herein, a set of elements or similar expressions may include one or more such elements. For example, a ‘set of convolution units’ may include one or more convolution units.

### Example Environment

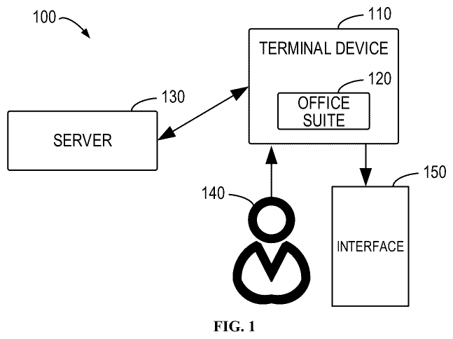

FIG. 1 illustrates a schematic diagram of an example environment 100 in which embodiments of the present disclosure may be implemented. In this example environment 100, an office suite 120 is installed in a terminal device 110. A user 140 may interact with the office suite 120 via the terminal device 110 and/or an attachment device of the terminal device 110. The office suite 120 may provide integration of a plurality of applications or components to the user 140. These applications may serve as application modules in the office suite 120. The applications integrated in the office suite 120 are sometimes referred to as ‘office applications’, ‘office components’, ‘collaborative office platforms’, and the like. As an example, applications integrated in the office suite 120 may include, but are not limited to, one or more of: a chat application (also referred to as an instant messaging (IM) application), a document application, an audio and video conferencing application, an email application, a calendar application, a schedule application, a task application, an object and key result (OKR) application.

In some embodiments, the office suite 120 may be downloaded as an application, installed on the terminal device 110. In some embodiments, the office suite 120 may also be accessed in other manners, such as through web access, etc.

In the environment 100 of FIG. 1, when the office suite 120 is launched, the terminal device 110 may present an interface 150 of the office suite 120 to the user 140. The interface 150 is also sometimes referred to as a client interface. The interface 150 may include various interfaces that may be provided by the office suite 120, such as a conversation interface presenting a chat content, a video conference interface, a file sharing interface, and the like.

In some embodiments, the terminal device 110 communicates with the server 130 to implement provision of services to the office suite 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a ‘wearable’ circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for example purposes only and do not imply any limitation to the scope of the present disclosure. For example, embodiments of the present disclosure may be applied to any suitable one or more applications, not limited to office suites.

As briefly mentioned above, a digital assistant may be provided to the user to assist the user in completing the target task using the terminal device or application. In an embodiment of the present disclosure, a digital assistant is configured for the user 140. The digital assistant may be implemented in any suitable form. In some embodiments, the digital assistant of the user 140 may interact with a contact of user 140. The digital assistant may also uniquely correspond to user 140. In other words, the digital assistant of the user 140 may be specific or specific to the user 140. When the user 140 is an individual or an individual, the digital assistant may be considered a personal digital assistant. It may be understood that the digital assistant in the embodiments of the present disclosure is based on the authorization of the user 140 to access the data to be granted.

It should be understood that the ‘unique correspondence’ or the like in the present disclosure is not intended to limit that the digital assistant will be updated accordingly based on the interaction process between the user 140 and the digital assistant.

In an embodiment of the present disclosure, the digital assistant is configured to interact with a user. An interaction window of the user with the digital assistant may be presented in the client interface. The digital assistant serves as an intelligent assistant and has capabilities of intelligent dialogue and information processing. In the interaction window, the user enters an interaction message, and in response to the user input, the digital assistant provides a reply message. A client interface for providing a digital assistant may correspond to a single functional application or a multifunction collaboration platform, such as an office suite or other collaboration platform capable of integrating multiple components.

The interaction window between the user and the digital assistant may include a conversation window, and the interaction between the user and the digital assistant in the conversation window may be presented in a form of a conversation message. Alternatively, or in addition, the interaction window of the user and the digital assistant may further include a non-conversation window, for example, a window of a floating window mode. The user may trigger the digital assistant to perform a corresponding operation by inputting an instruction, selecting a shortcut instruction, or the like.

In some embodiments, after waking up the digital assistant through the predetermined application, the user 140 interacts with the digital assistant through the primary conversation. The interaction window corresponding to the primary conversation may be referred to as a primary conversation window. As an example, the predetermined application may be an IM application in an office suite. In other examples, the predetermined application may also be a further application or component.

In some embodiments, the digital assistant may be woken up and interacted with through further applications other than the predetermined application. After waking up the digital assistant through the non-predetermined applications, the user and the digital assistant may interact through a secondary conversation. An interaction window corresponding to the secondary conversation may be referred to as a secondary conversation window. For example, a user may invoke a digital assistant through a page in a document application, thereby interacting with the digital assistant through the secondary conversation.

As briefly described above, the terminal device or application may provide a digital assistant class function to the user to assist the user in using the terminal device or application. However, user interaction flexibility with a digital assistant is a technical problem to be explored currently.

In some embodiments, the digital assistant may be caused to utilize one or more plug-ins to assist the user in interacting with the digital assistant. Each plug-in is configured to perform a corresponding function. When the user may select some or some of the plug-ins before sending the corresponding instruction, it is beneficial for the digital assistant to clarify the operation purpose of the user.

In some embodiments, when the user interacts with the digital assistant, the digital assistant may assist the user based on the scenario. The scenario herein refers to a set of tasks of a same type, that is, one scenario corresponds to a plurality of tasks of a same type. One or more scenarios may be configured with corresponding configuration information to perform corresponding types of tasks, respectively. The configuration information of the scenario includes at least one of the following: scenario setting information and plug-in information. The scenario setting information is configured to describe information related to a corresponding scenario. The plug-in information indicates at least one plug-in for performing a task in a corresponding scenario. As will be discussed below, the configuration information of the scenario may also include, for example, an indication of the selected model (the model here is called to determine a reply to the user in the corresponding scenario), scenario guidance information (the scenario guidance information is presented to the user after the corresponding scenario is selected), at least one question recommended for the digital assistant (at least one question recommended is presented to the user after the corresponding scenario is selected for selection), and/or the like. In some embodiments, the scenario setting information and the configuration information configuration of the scenario may be completed in a natural language manner, such that the scenario creator may conveniently constrain the output of the model and configure diversified scenarios.

The scenario setting information of the scenario may affect the reply of the digital assistant to the user to a certain extent, or be used to determine the reply of the digital assistant to the user. In some embodiments, the scenario setting information is configured to construct a prompt input to provide to the model used in the corresponding scenario. The reply of a digital assistant to the user is based on the output of the model. For example, the scenario setting information of the scenario may include a description of a task of a corresponding type, a reply style of the digital assistant in the scenario, a definition of a workflow to be performed in the corresponding scenario, a definition of a reply format of the digital assistant in the corresponding scenario, and the like. In some embodiments, the digital assistant will understand the user input via a model and provide a reply to the user based on the output of the model. The model used by the digital assistant may run local to the terminal device 110 or at a remote server. By constructing a part of the prompt input of the model with the scenario setting information, the model may be guided to complete the task to be implemented in the corresponding scenario.

Through the plug-in information of the scenario, the plug-in to be used in the corresponding scenario may be configured. In some embodiments, in the corresponding scenario, in the running of the plug-in, the plug-in may also invoke the model to complete the corresponding task. In some embodiments, a plug-in may also invoke a start interface provided by a further application (for example, an application such as a document, a calendar, a conference, etc.) to complete a corresponding task, such as modifying a document, creating a schedule, summarizing a conference, and the like.

Embodiments of the present disclosure provide an improved solution for information interaction. According to various embodiments of the present disclosure, when a predetermined operation associated with a conversation window of a user and a digital assistant is detected, a first message from the digital assistant in the conversation window is presented. An element related to one or more task components is presented in the first message. Each task component is configured to perform a corresponding function. The task component includes at least one of a plug-in or a scenario. In this way, how the user interacts with the digital assistant may be guided using the task component. In turn, the digital assistant may more accurately clarify the operational goal of the user to give more accurate results. In this way, the user assisted efficiency of the digital assistant may be further improved.

Some example embodiments of the present disclosure will be described below with continued reference to the accompanying drawings. In the embodiments described below, plug-ins are used as examples of task components. It should be understood, however, that aspects described with respect to the plug-in are equally applicable to scenarios. It should be understood that the pages shown in the drawings are merely examples, and various page designs may actually exist. Individual graphical elements in a page may have different arrangements and visual representations, one or more of which may be omitted or replaced, and one or more other elements may also be present. Embodiments of the present disclosure are not limited in this respect.

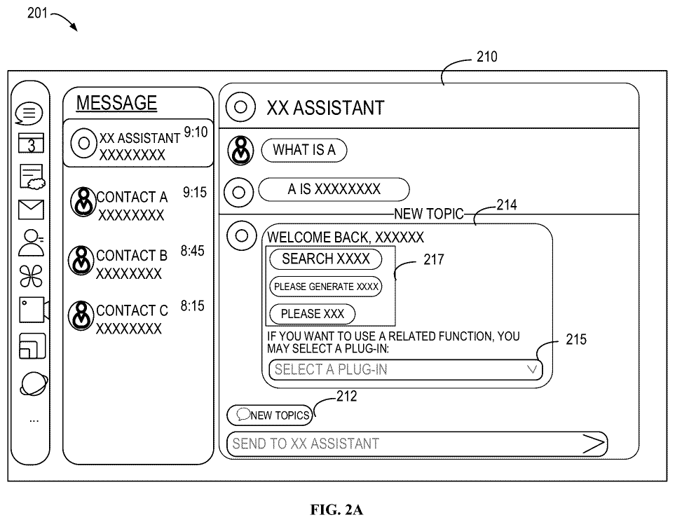

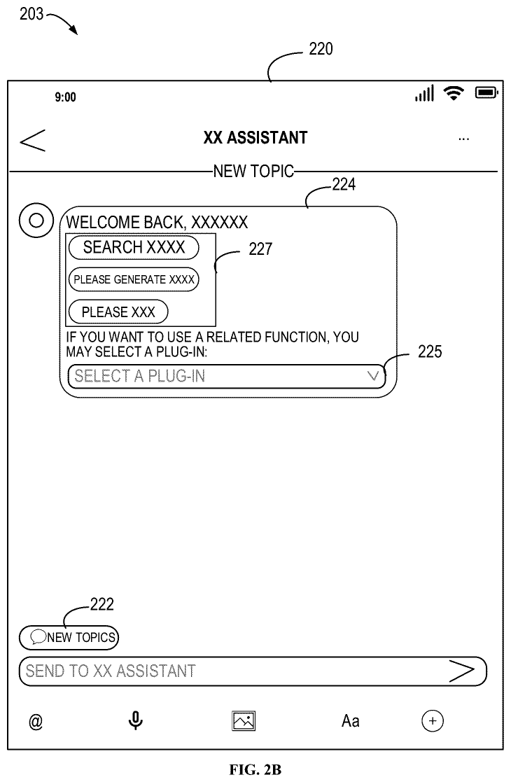

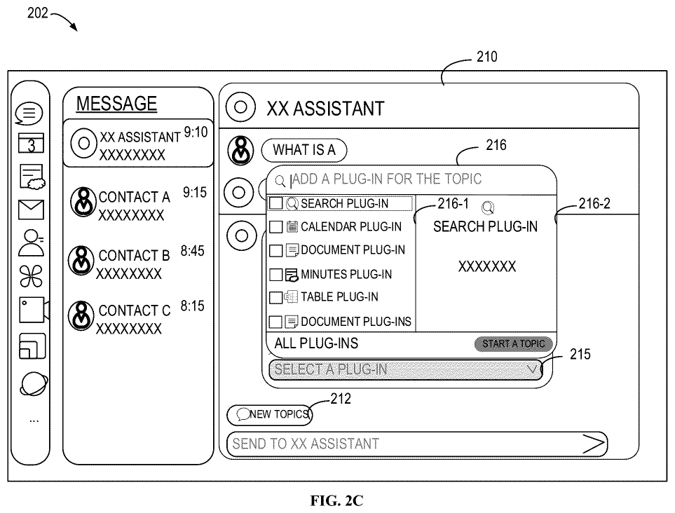

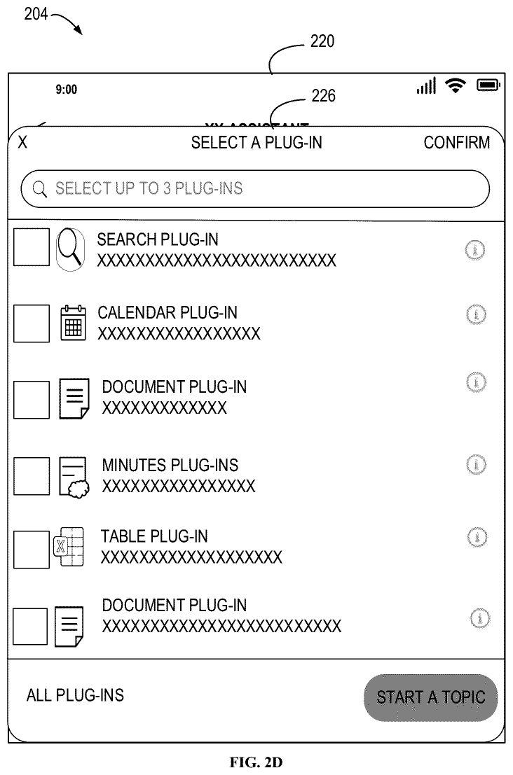

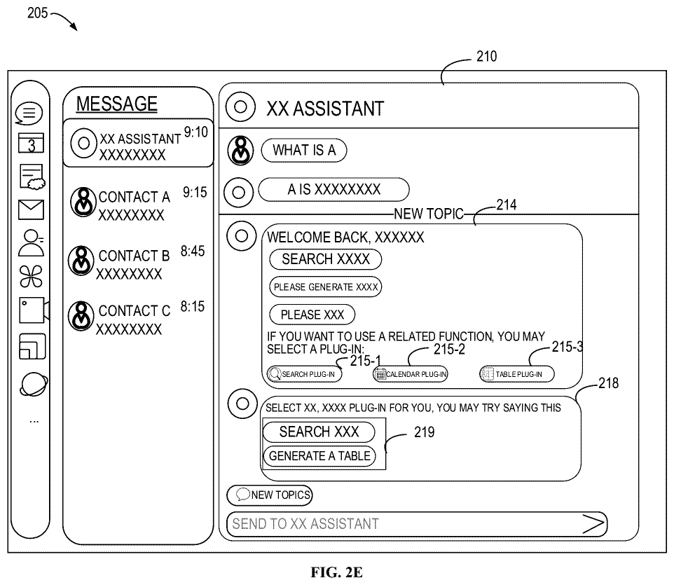

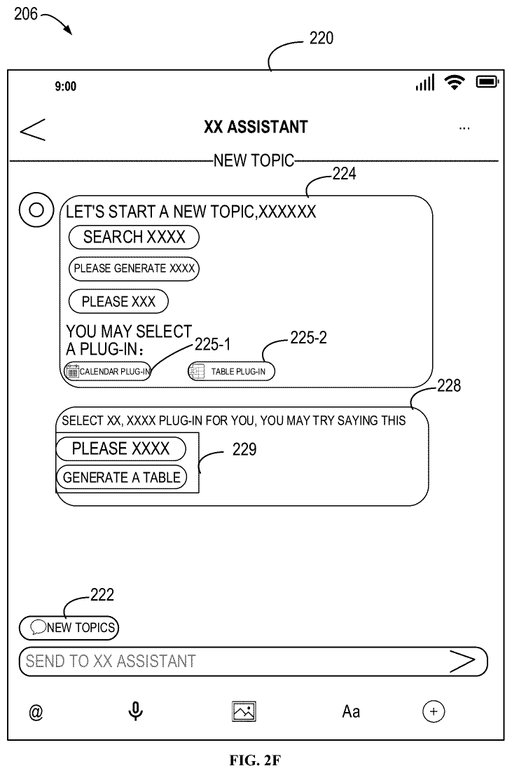

FIGS. 2A-2F illustrate schematic diagrams of example interfaces according to some embodiments of the present disclosure. After the user 140 performs the predetermined operation, the terminal device 110 presents the first message from the digital assistant. In the following, FIGS. 2A to 2F are described with the perspective of the terminal device 110 for ease of discussion, but this is merely for example.

In some embodiments, the terminal device 110, in response to a predetermined operation associated with a conversation window of the user 140 and a digital assistant, presents a first message from the digital assistant in the conversation window. In some embodiments, the predetermined operation may include an operation of starting a new topic in the conversation window. In an interface 201 shown in FIG. 2A, the user 140 clicks on a new topic control 212 in a conversation window 210. Hereinafter, for ease of discussion, the conversation window is taken as the primary conversation window 210 as an example. Herein, a ‘topic’ corresponds to a particular context of an interaction. During the interaction process of each topic, the interaction information of the user and the digital assistant may be considered as context information, to assist the digital assistant in determining a subsequent conversation message. In some embodiments, a topic is also sometimes referred to as or presented as a theme.

In an example, after the user 140 clicks on the new topic control 212 in the conversation window 210, the terminal device 110 will present the first message from the digital assistant in the conversation window 210, such as a first message 214 and a first message 224 in the interface shown in FIGS. 2A and 2B. The terminal device 110 supports the user 140 forwarding a first message 214 and the first message 224, multi-selecting the first message 214 and the first message 224, and copying a link to the first message 214 and the first message 224, and so on. The first message 214 and the first message 224 may include but are not limited to: a greeting message. The interfaces shown in FIGS. 2A and 2B is described below: the interface shown in FIGS. 2A and 2B expresses the same function, but is only presented in a different form because of the different types of terminal devices 110.

In some embodiments, the terminal device 110 presents the element related to one or more plug-ins in the first message. Each plug-in is configured to perform a corresponding function. In some embodiments, the terminal device 110 may present, in the first message 214, a plug-in selection control. As shown in the interface 201 shown in FIG. 2A, the terminal device 110 presents, in the first message 214 in the conversation window 210, a plug-in selection control 215. As shown in an interface 203 shown in FIG. 2B, the terminal device 110 presents, in the first message 224, a plug-in selection control 225.

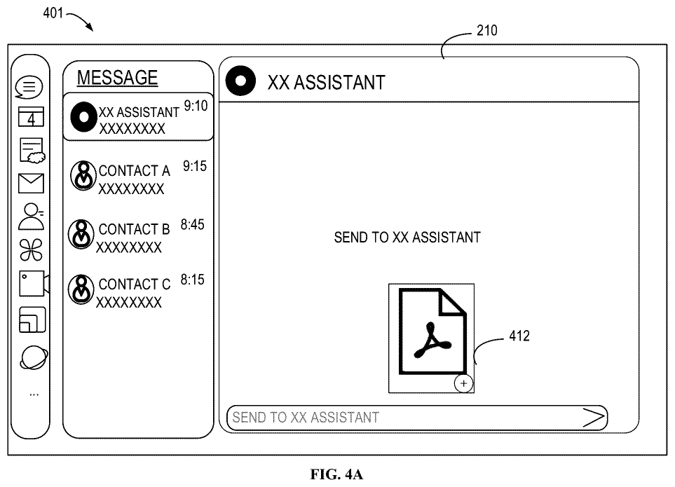

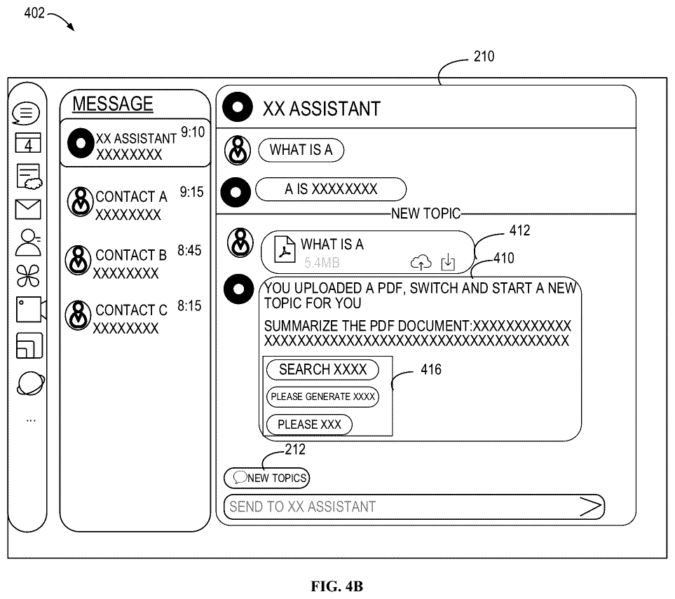

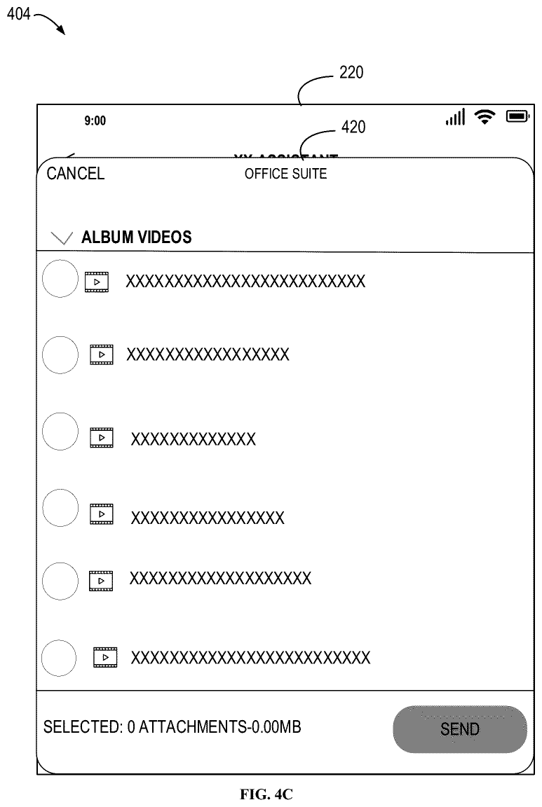

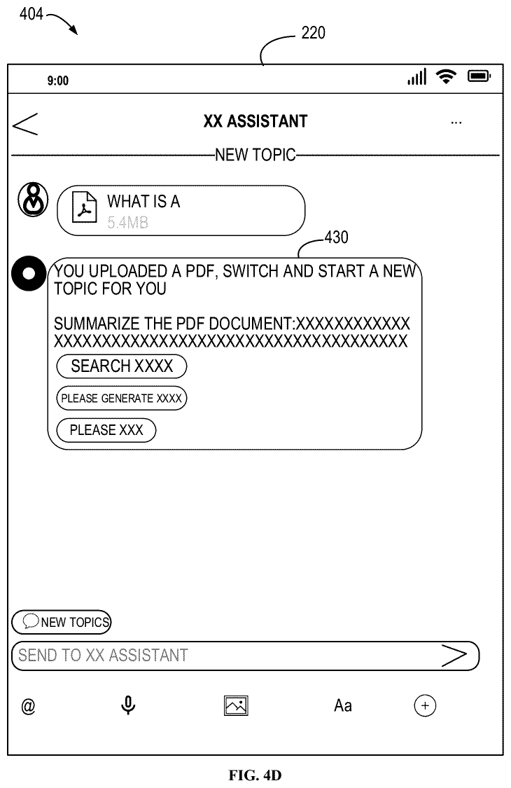

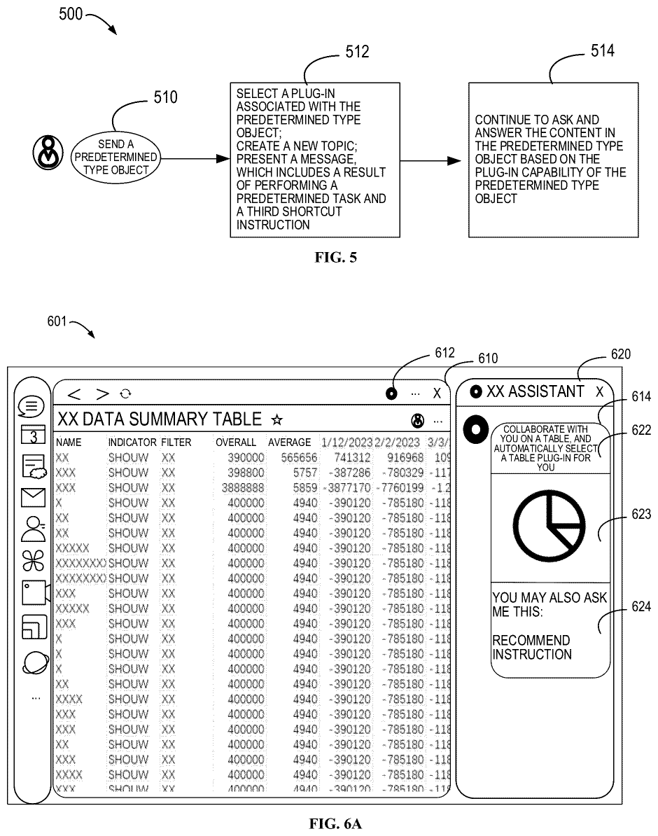

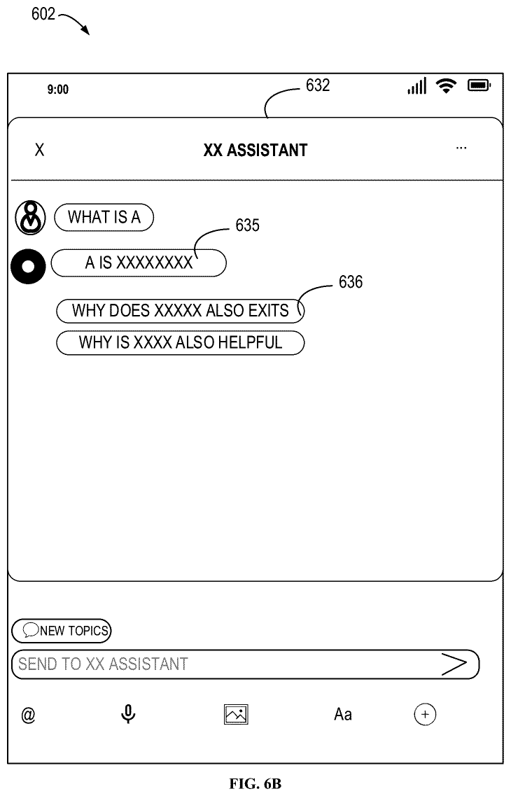

In some embodiments, the presented elements related to the one or more plug-ins may be a result of performing a predetermined task with a plug-in associated with the predetermined type object. Example embodiments of information interaction will be described in detail below with reference to FIGS. 4A to 4D. Alternatively, or in addition, in some embodiments, the presented elements may be prompt information. Example embodiments of information interaction will be described in detail below with reference to FIGS. 6A to 6B.

Continuing with the description in FIG. 2A to FIG. 2F, the terminal device 110 presents, in the first message, one or more first shortcut instructions recommended. At this time, since the user 140 does not select the plug-in, the one or more first shortcut instructions recommended are universal, irrelevant to the plug-in, and the one or more shortcut instructions are triggerable. As shown in FIG. 2A, the terminal device 110 presents the one or more first shortcut instructions 217 recommended in the first message 214. As shown in FIG. 2B, the terminal device 110 presents, in the first message 224, the one or more first shortcut instructions 227 recommended. The first shortcut instruction 217 recommended is triggerable. For example, the terminal device 110 performs a corresponding operation based on the first shortcut instruction 217 clicked by the user 140, and presents a corresponding result.

In some embodiments, the first shortcut instruction 217 includes one or more types. For example, the type of the first shortcut instruction may be a recommendation instruction generated by the model. The user 140 may directly click on the shortcut instruction. For a further example, a type of the first shortcut instruction may be an instruction configured by the platform. After the user 140 clicks on this type of shortcut instruction, the terminal device 110 may determine whether the shortcut instruction has parameters. In the case of a shortcut instruction with parameters, an input block may be presented to the user 140. After the user 140 completes the information through the input block, the shortcut instruction is sent to the server. In the case of a shortcut instruction without parameters, the user 140 may click on the shortcut instruction, and the shortcut instruction may be sent directly to the server.

In one example, the one or more first shortcut instructions are triggerable. After the user 140 clicks on the one or more first shortcut instructions presented in the first message 214, the terminal device 110 determines whether the first shortcut instruction is valid. When the first shortcut instruction is in effect, the user 140 may always click to perform the first shortcut instruction, regardless of subsequent messages. When the first shortcut instruction is disabled and the user 140 then clicks to send the first shortcut instruction, the digital assistant will not be able to perform the shortcut instruction and may, for example, reply to the user in the form of a message to inform the user that the instruction could not be performed other instructions may be attempted.

In some embodiments, the terminal device 110, in response to a trigger on the task component selection control, presents a plug-in selection panel. As shown in an interface 202 shown in FIG. 2C, the terminal device 110, in response to a trigger on the plug-in selection control, presents a plug-in selection panel 216 in the conversation window 210. The plug-selection panel 216 includes at least a list of selectable plug-ins 216-1. For example, the list of selectable plug-ins 216-1 may include, but is not limited to, a search plug-in, a calendar plug-in, a document plug-in, a minutes plug-in, a table plug-in, and so on. FIG. 2D illustrates a plug-in selection panel 226 displayed in the conversation window 220 as a further example. The interfaces shown in FIGS. 2C and 2D are described below: the functions expressed by the interfaces shown in FIGS. 2C and 2D expresses the same function, except that they are presented differently because of the different types of terminal devices 110.

In an example, after the user 140 clicks on a selection plug-in entry 215 as shown in FIG. 2A, the terminal device 110 presents the selection panel 216 in the conversation window 210. Further, the user 140 may select at least one plug-in. In some embodiments, the number of plug-ins that may be selected is related to the machine learning model utilized.

In some embodiments, the terminal device 110, in response to a selection of at least one plug-in in the list, obtains at least one plug-in selected by the user 140. For example, the user 140 selects at least one plug-in in the list 216-1, and the terminal device 110 obtains at least one plug-in in the user 140 selection list 216-1 and performs a corresponding operation.

In some embodiments, the terminal device 110 may present the identification information of the at least one plug-in selected by the user 140 in the first message. As shown in an interface 205 shown in FIG. 2E, after the user 140 selects at least one plug-in in the list 216-1, for example, a plug-in, a calendar plug-in, a table plug-in, etc., the terminal device 110 presents identification information of plug-ins such as a search plug-in 215-1, a calendar plug-in 215-2, and a table plug-in 215-3 in the first message 214. As shown in an interface 206 shown in FIG. 2F, after the user 140 selects at least one plug-in in a list 226-1, for example, a plug-in such as a calendar plug-in or a table plug-in, the terminal device 110 presents identification information of plug-ins such as a calendar plug-in 225-1 and a table plug-in 225-2 in the first message 224. The interfaces shown in FIGS. 2E and 2F are described below: the functions expressed by the interfaces shown in FIGS. 2E and 2F are the same, except that they are presented differently because of the different types of terminal devices 110.

In some embodiments, the terminal device 110 may present the identification information of the at least one plug-in selected by the user 140 in a third message, that is, present the identification information in a new message. After the user 140 selects at least one plug-in in the list 216-1, for example, a search plug-in, a calendar plug-in, a table plug-in, etc., the terminal device 110 presents identification information of plug-ins such as the search plug-in 215-1, the calendar plug-in 215-2, and the table plug-in 215-3 in the third message. The third message may be a third message generated by the digital assistant based on the plug-in selected by the user 140. The third message may be composed of a user selected plug-in.

In one example, the plug-in selection panel 216 also includes a plug-in search area. As shown in FIG. 2C, the terminal device further provides a plug-in search area 216-2 in the plug-in selection panel 216, and the plug-in search area is configured to search for plug-ins.

In some embodiments, the terminal device 110 presents a second message from the digital assistant in the conversation window 210, as shown in the interface shown in FIGS. 2E and 2F, and the terminal device 110 presents a second message 218 and a second message 228 from the digital assistant in the conversation window 210. After the user 140 selects at least one plug-in, the user is prompted in the second message that he/she has selected the plug-in and may utilize the selected plug-in.

In some embodiments, the terminal device 110 presents, in the second message 218, one or more second shortcut instructions recommended. The one or more second shortcut instructions are triggerable and suitable for performing a relevant operation by the at least one plug-in after being triggered. As shown in FIG. 2E, after the user 140 selects the at least one plug-in, the terminal device 110 presents, in the second message 218, the one or more second shortcut instructions 219 recommended. As shown in FIG. 2F, after the user 140 selects the at least one plug-in, the terminal device 110 presents, in the second message 228, the one or more second shortcut instructions 229 recommended. In an example, since the second message is a message that the terminal device 110 replies to after the user 140 selects a plug-in, the one or more second shortcut instructions 219 presented in the second message are operations related to the execution of at least one plug-in.

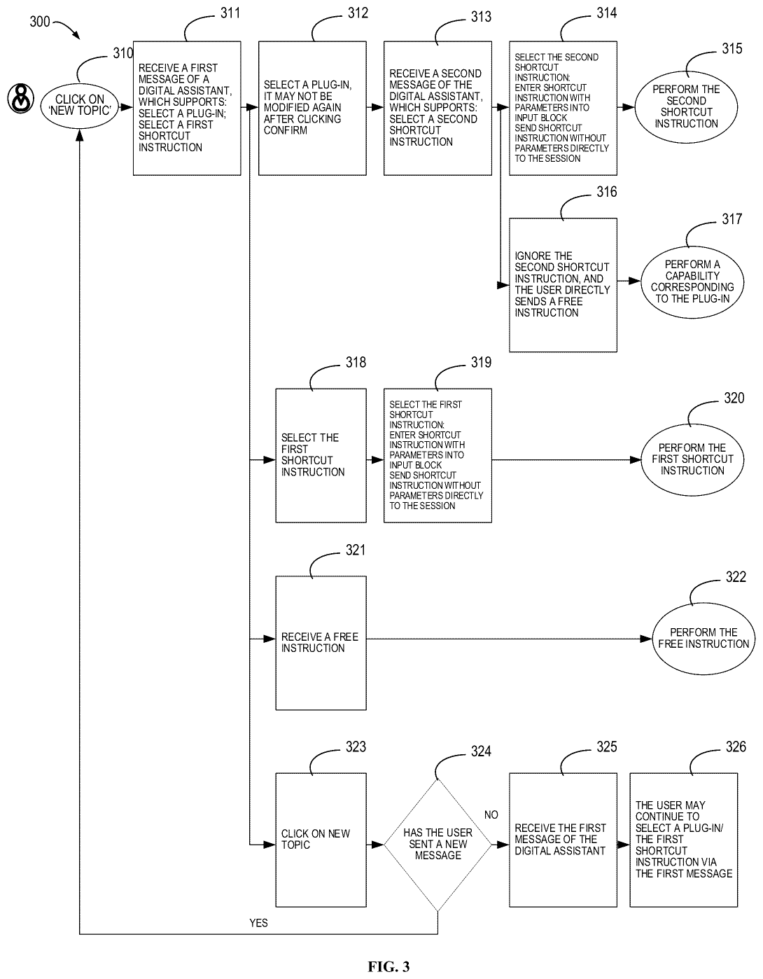

FIG. 3 illustrates a flowchart of an example process 300 for information interaction according to some embodiments of the present disclosure. Referring to FIG. 3, and with reference to FIG. 2A to FIG. 2F, after the user 140 performs the predetermined operation, the terminal device 110 presents the first message from the digital assistant, and then the user 140 selects a plug-in on the first message returned by the digital assistant.

At block 310, the user 140 clicks on New Topic control. The terminal device 110 may start a new context of the digital assistant based on the user 140 clicking on the new topic, that is, the terminal device 110 may decouple the context before the user 140 clicks on the new topic from the subsequent context. After receiving and presenting the first message in the conversation window 210, the terminal device 110 may select a plug-in, the user 140 may ignore the second shortcut instruction, directly send the free instruction, the user 140 may select the first shortcut instruction, the user 140 may reply to the free instruction, and the user 140 may click on New Topic again.

After receiving and presenting the first message in the conversation window 210, the user 140 may select the plug-in, and the terminal device performs the corresponding operation based on the plug-in selected by the user.

At block 311, after the user 140 clicks on the new topic, the first message 214 returned by the digital assistant is received. The first message 214 supports the user 140 selecting at least one plug-in or supporting the user selecting one or more first shortcut instructions. The first message 214 may include three parts, such as the interface 201 shown in FIG. 2A, and the first message 214 includes: a greeting message, one or more first shortcut instructions 217, and an entry 215 that the user 140 selects at least one plug-in.

At block 312, the user 140 selects the plug-in and clicks on the confirmation, and the plug-in cannot be modified again. As shown in FIG. 2C, the user 140 selects the plug-in entry 215 by clicking, and the terminal device 110 presents the selection panel 216 in the conversation window 210. The selection panel 216 includes a list of selectable plug-ins 216-1. The user 140 clicks on the plug-in in the list 216-1 of the selectable plug-in and clicks on Confirm, and the user 140 cannot make a modification after confirming.

At block 313, when the user 140 selects the plug-in and confirms, the user 140 may receive a second message of the digital assistant. As shown in FIG. 2E, the terminal device 110 presents the second message 218 in the conversation window 210. The second message 218 supports the user 140 to select the second shortcut instruction, as shown in FIG. 2E, and the second message 218 includes the second shortcut instruction 219.

In an example, since the second shortcut instruction 219 is generated after the user 140 selects and confirms the plug-in, the second shortcut instruction 219 is related to the plug-in selected and confirmed by the user. For example, when the user selects a search plug-in, a calendar plug-in, and a table plug-in, the second shortcut instruction 219 searches for a latest message, reserves a conference, and generates a table.

At block 314, the second shortcut instruction 219 includes, but is not limited to, a plurality of types, for example, a second shortcut instruction generated by the model, which supports the user 140 clicks to send directly; and the second shortcut instruction configured by the terminal device 110 supports the user 140 to click, and determines whether it is with parameters. For a shortcut instruction with parameters, the user 140 may click on the entry block to perform completion information and send the completion information. For a shortcut instruction without parameters, the user may click to send directly. At block 315, the digital assistant performs a second shortcut instruction selected by the user.

At block 316, after the user 140 clicks on the new topic, the first message presented in the conversation window 210 is received. The first message supports the user 140 selecting the plug-in and the user 140 will receive the second message after selecting the plug-in. The second message supports the user 140 to select the second shortcut instruction, but the user 140 may ignore the second shortcut instruction and send the free instruction directly. Further, the terminal device 110 performs the capability corresponding to the plug-in.

At block 318, after the terminal device 110 clicks on the new topic based on the user 140, the terminal device 110 may receive and present the first message in the conversation window 210, wherein the first message supports the user to select the first shortcut instruction 217.

At block 319, the first shortcut instruction 217 includes, but is not limited to, a plurality of types, for example, the first shortcut instruction 217 generated by the model supports the user 140 to clicks to send directly; and the first shortcut instruction 217 configured by the terminal device 110 supports the user 140 to click and determine whether the parameter exists. For a shortcut instruction with parameters, the user 140 may click on the entry block to perform completion information and send the completion information. For a shortcut instruction without parameters, the user 140 may click to send directly. At block 320, the digital assistant performs a corresponding operation of the first shortcut instruction 217 based on the first shortcut instruction 217 selected by the user 140.

At block 321, after the user 140 clicks on the new topic and receives the first message of the digital assistant, the user may select a reply free instruction. For example, the user 140 continues to reply to historical information. At block 322, the terminal device 110 performs its corresponding operation based on the free instruction of the user 140.

At block 323, the user 140 clicks on the new topic. At block 324, after the user 140 clicks on the new topic again, the terminal device 110 determines whether the user 140 has sent a message. When the user 140 sent a message, the process returns to block 310. When the user 140 does not send a message, the user 140 may receive a first message of the digital assistant at block 325. At block 326, the user 140 may continue to select the plug-in or select the first shortcut instruction through the first message.

The operation of starting the new topic in the conversation window is described above. Alternatively, or in addition, in some embodiments, the predetermined operation may include receiving a user input indicating a predetermined type object in a conversation window of the user and the digital assistant. In this embodiment, the terminal device 110 may perform the result of the predetermined task in the first message with the plug-in associated with the predetermined type object. The predetermined type object may be any suitable type of object, such as a particular type of document, a multimedia file, or the like. In some embodiments, the predetermined type object may be a portable document format PDF file. Correspondingly, the plug-in associated with the predetermined type object may be a PDF plug-in. The predetermined task may be any suitable task that the plug-in may perform, such as a summary document.

FIGS. 4A to 4D illustrate schematic diagrams of example interfaces according to some embodiments of the present disclosure. In the following, FIGS. 4A to 4D are described with the perspective of the terminal device 110 for ease of discussion, but this is merely for example.

In some embodiments, the terminal device 110 presents, in the first message, a result of performing a predetermined task with a task component associated with the predetermined type object. The predetermined type object includes a PDF file that may carry a document format, and the terminal device 110 may further present, in the first message, summary information of the PDF file generated with the PDF plug-in. As shown in an interface 401 of FIG. 4A, the user 140 sends a PDF file 412 to the digital assistant via the conversation window 210. In an interface 402 shown in FIG. 4B, the terminal device 110 presents a first message 410 in the conversation window 210. The summary information of the PDF file 412 generated with the PDF plug-in is shown in the first message 410.

In some embodiments, the terminal device 110 may present, in the first message, the one or more third shortcut instructions recommended. As shown in the interface 402 shown in FIG. 4B, the terminal device 110 presents, in the first message of the conversation window 210, the one or more third shortcut instructions 416 recommended. The one or more third shortcut instructions 416 may be triggered by the user 140 and the third shortcut instruction is associated with a predetermined type object. For example, the user 140 sends the PDF file 412 to the digital assistant. In this case, the shortcut instruction 415 recommended is associated with the PDF file 412.

The interface shown in FIGS. 4C and 4D is a case in which the terminal device 110 is a mobile terminal. As shown in FIG. 4C, the user may select a file to send in a conversation window 220. When the user sends the PDF file, the terminal device 110 presents a message 430, wherein the summary of the PDF file content and the shortcut instruction recommended are displayed.

FIG. 5 illustrates a flowchart of an example process for information interaction according to some embodiments of the present disclosure. The process 500 is described below in conjunction with FIGS. 4A to 4D. At block 510, the user 140 sends a predetermined type object. The predetermined type object may include, but is not limited to, a PDF file, a document file, a form file, and the like. This is not limited in the present disclosure.

At block 510, the user 140 sends a predetermined type object to the digital assistant. At block 512, the terminal device 110 automatically selects a plug-in associated with the predetermined type object, such as a PDF plug-in; creates a new topic, and clears the context prior to receiving the PDF file; and presents a message including the result of performing the predetermined task and the one or more third shortcut instructions 416.

At block 514, the user may continue to answer the content in the predetermined type object based on the plug-in capability of the predetermined type object. For example, the one or more third shortcut instructions presented may include a shortcut instruction that ‘summarize this PDF in sections’, the shortcut instruction ‘how many images are in this document’. The user 140 may click on one or more third shortcut instructions. For example, when the user 140 clicks on the shortcut instruction for ‘Summarize this PDF in sections’, the terminal device 110 would present a result corresponding to ‘Summarize this PDF in sections’ based on the reply of the digital assistant.

FIGS. 6A to 6B illustrate schematic diagrams of example interfaces according to some embodiments of the present disclosure. After the terminal device 110 performs the predetermined operation on the user 140, the terminal device 110 presents the first message from the digital assistant, and then the terminal device 110 presents the prompt information in the first message. In the following, for ease of discussion, 6A to 6B are described with the perspective of the terminal device 110, but this is merely for example. In the following, for ease of discussion, the conversation window may be a secondary conversation window 620.

In some embodiments, the terminal device 110, in response to a predetermined operation associated with a conversation window 610 of a user and a digital assistant, presents a first message from the digital assistant in the conversation window 620. The predetermined operation may include, but is not limited to, triggering the conversation window 620 via the first application or receiving a user input in the conversation window 620 triggered via the first application. The first application may be any application, such as an office software, communication application, search application, or the like.

In some embodiments, the terminal device 110 may present, in the first message, the prompt information. The prompt information indicates a plug-in selected by default for the first application. In some embodiments, in response to the trigger of the shortcut instruction by the user 140, the terminal device 110 performs the task corresponding to the shortcut instruction with the plug-in selected by default. As shown in an interface 601 shown in FIG. 6A, the terminal device 110 presents prompt information 622 in a first message 614 in the conversation window 620. In this example, the first application may be a table application, and the prompt information 622 indicates that a table plug-in has been selected for the user.

In some embodiments, the terminal device 110 may present, in the first message, a plug-in selection control for the user to freely select the plug-in. In such an embodiment, instead of or in addition to the default plug-in, the user may select the plug-in that wants to use according to actual needs.

In some embodiments, the terminal device 110 further presents, in the first message, information for a task executable by the first application. For example, the first application may be a document application. Accordingly, the task information executable for the first application may be, for example, ‘I can help you with summarizing the document or quizzing based on the content of the document’.

In some embodiments, the terminal device 110 further presents, in the first message, a result of performing a task related to the first application. As shown in the interface 601 shown in FIG. 6A, the terminal device 110 presents, in the conversation window 620, a result 623 of performing a task related to the first application. In this example, a pie chart, or insight information, etc. is presented.

In some embodiments, the terminal device 110 further presents, in the first message, a shortcut instruction performable for the first application. As shown in the interface 601 shown in FIG. 6A, the terminal device 110 may present, in the first message 214 in the conversation window 620, a shortcut instruction 624 for a table application.

In some embodiments, the terminal device 110 further presents, in the first message, a query for a recommendation related to the first application. The terminal device 110 may present a further query for the recommendation in the first message 214 in the conversation window 620.

The interface 602 shown in FIG. 6B is for the terminal device 110 as a mobile terminal. The terminal device 110 presents a message 635 and a shortcut instruction 636 in a conversation window 632.

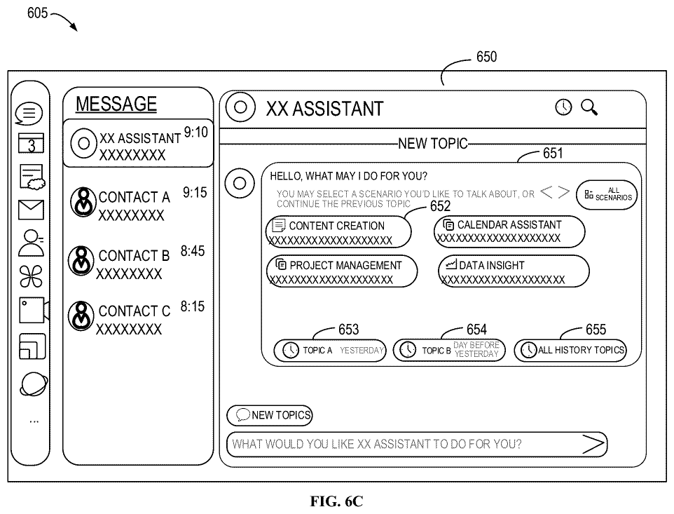

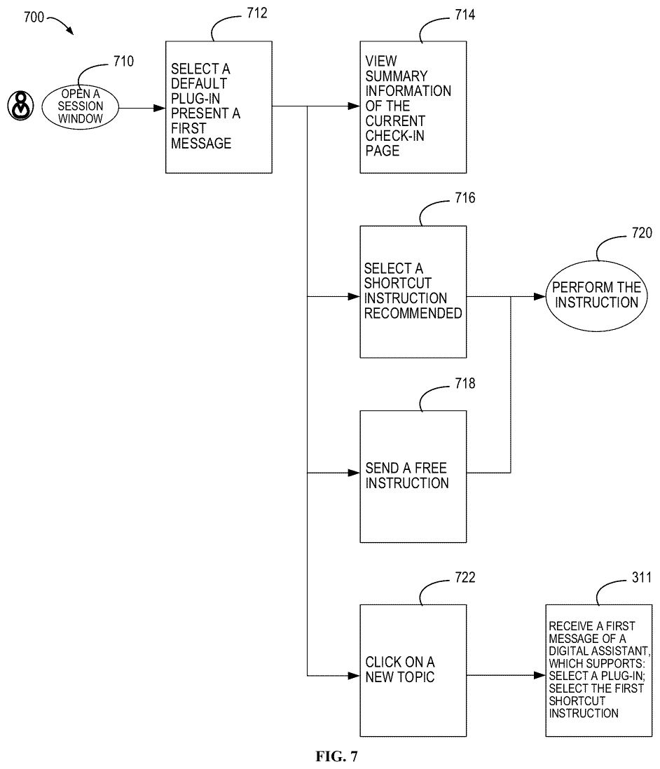

FIG. 7 illustrates a flowchart of an example process 700 for information interaction according to some embodiments of the present disclosure. The example process 700 is described below in connection with FIGS. 6A to 6B. At block 710, the terminal device 110 opens the conversation window 620 based on the user 140 clicking on the digital assistant corresponding control 612. The conversation window 620 may be a secondary conversation window.

At block 712, the terminal device 110 automatically selects a default plug-in and presents a first message. The terminal device 110 presents prompt information 622 in the first message. For example, when the first application is a document, the prompt information 622 may be: ‘Collaborating with you in XX document, assuming you automatically selected the document plug-in’. At block 714, the user 140 may view summary information for the current opened page.

At block 716, the user 140 selects the shortcut instruction recommended in the first message. At block 718, the user 140 may ignore the shortcut instruction recommended, but instead send a free instruction. At block 720, the terminal device 110 or the digital assistant performs a corresponding operation according to the free instruction sent by the user 140 or the shortcut instruction selected.

At block 722, when the user 140 clicks on the new topic button in the conversation window 620, the terminal device 110 performs subsequent operations. The subsequent operations performed by the terminal device are consistent with operations performed after the user clicks on the new topic, which is not described herein.

In some embodiments, one or more of the messages described above may be presented in the form of a message card. For example, messages 214, 224, 218, 228, 410, 430, 614, etc. may be in the form of a message card. A message card may be an interface component that includes a content and an operation. The message card format allows messages to carry richer content, such as an icon, a document, a chart, a form, a control, etc., than messages in plain text form. In this way, the user can be better guided to interact with the digital assistant in order to improve the efficiency of assistance.

In some embodiments, a user may be enabled to view or re-start a historical topic between the user and the digital assistant. For example, an entry control of one or more topics may be presented in the foregoing first message, and one or more topics herein are historical topics between the user and the digital assistant.

One example is described with reference to FIG. 6C. The interface 605 shown in FIG. 6C includes a conversation window 650 between a user and a digital assistant. A first message 651 from the digital assistant is displayed in the conversation window 650. An entry control of one or more scenarios is presented in the first message 651, such as an entry control 652 for this scenario of ‘content creating’. The entry control may be used to enable a corresponding scenario.

Also presented in the first message 651 are entry controls 653, 653, and 655 for the topic. By triggering these entry controls, the user may view or re-start the historical topics. For example, by triggering the entry control 655, the user may view all of its historical topics with the digital assistant. Note that all historic al topics described herein may be all historical topics over a period of time. As a further example, by triggering the entry control 653, the user may view or re-start the topic A. In some embodiments, the entry control may also present the occurrence time or last update time of the corresponding topic. As shown in FIG. 6C, the occurrence time or last update time of topic A is yesterday.

Several example operations are described above with reference to terminal device 110. It should be understood that this is merely for example and some or all of these operations may be performed by a digital assistant.

### Example Processes

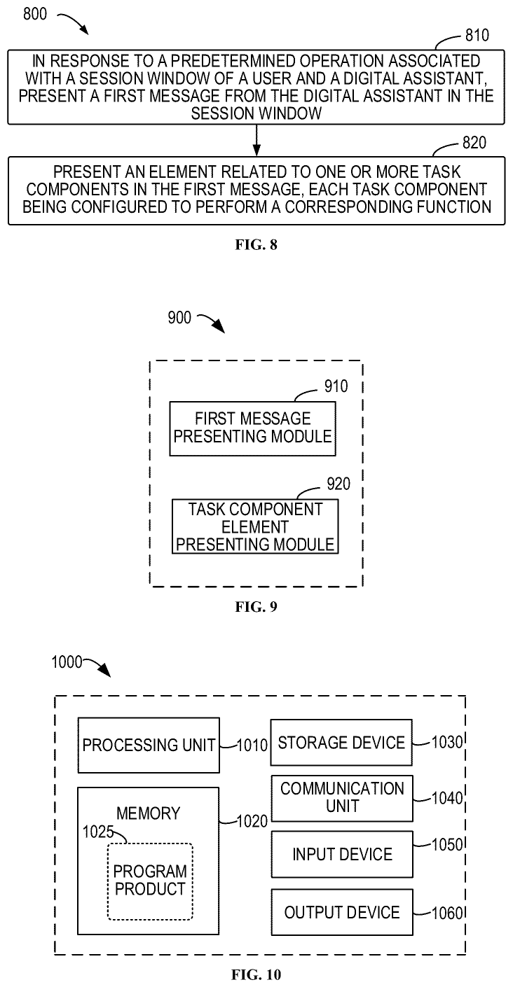

FIG. 8 illustrates a flowchart of a process 800 for information interaction according to some embodiments of the present disclosure. The process 800 may be implemented at terminal device 110. The process 800 is described below with reference to FIG. 1.

At block 810, the terminal device 110, in response to a predetermined operation associated with a session window of a user and a digital assistant, present a first message from the digital assistant in the session window.

At block 820, the terminal device presents, in the first message, an element related to one or more task components, each task component being configured to perform a corresponding function. The task component includes at least one of a plug-in or a scenario.

In some embodiments, the predetermined operation includes an operation of starting a new topic in the conversation window, and presenting the element related to one or more task components in the first message includes: presenting, in the first message, a task component selection control; or presenting, in the first message, a task component selection control and prompt information for task component selection.

In some embodiments, presenting the element related to one or more task components in the first message further includes: presenting, in the first message, one or more first shortcut instructions recommended, the one or more shortcut instructions being triggerable.

In some embodiments, presenting the element related to one or more task components in the first message further includes: in response to a trigger on the task component selection control, presenting a task component selection panel, the task component selection panel including at least a list of selectable task components; and in response to a selection of at least one task component in the list, obtaining at least one task component selected by the user.

In some embodiments, identification information of the at least one task component selected by the user is presented in the first message or in a third message.

In some embodiments, a task component search area is provided in the task component selection panel for searching a task component.

In some embodiments, a second message from the digital assistant is presented in the conversation window; and one or more second shortcut instructions recommended are presented in the second message, the one or more second shortcut instructions being triggerable and suitable for performing a relevant operation by the at least one task component after being triggered.

In some embodiments, the process 800 further includes that the predetermined operation includes receiving, in the conversation window, a user input indicating a predetermined type object, and presenting, in the first message, the element related to one or more task components includes: presenting, in the first message, a result of performing a predetermined task with a task component associated with the predetermined type object.

In some embodiments, the predetermined type object includes a portable document format PDF file, and presenting the result includes: presenting, in the first message, summary information of the PDF file generated with a PDF task component.

In some embodiments, one or more third shortcut instructions recommended are presented in the first message, the one or more third shortcut instructions being triggerable and associated with the predetermined type object.

In some embodiments, the predetermined operation includes: triggering the conversation window via a first application, or receiving a user input in the conversation window triggered via a first application, and presenting, in the first message, the element related to one or more task components includes at least one of: presenting prompt information in the first message, the prompt information indicating a task component selected by default for the first application, or presenting, in the first message, a task component selection control.

In some embodiments, the first message further presents at least one of: information about a task performable for the first application, a result of performing a task related to the first application, a shortcut instruction performable for the first application, or a query for a recommendation related to the first application.

In some embodiments, in response to a trigger for the shortcut instruction, a task corresponding to the shortcut instruction is performed with the task component selected by default.

In some embodiments, the scenario is configured with configuration information, and the configuration information includes at least one of: scenario setting information, or plug-in information, wherein the scenario setting information is configured to describe information related to a corresponding scenario, and the plug-in information indicates at least one plug-in configured to perform a task in the corresponding scenario.

In some embodiments, the process 800 further includes: presenting, in the first message, an entry control of one or more topics, the one or more topics being historical topics between the user and the digital assistant.

In some embodiments, the message is presented in a form of a message card.

### Example Apparatus and Apparatus

FIG. 9 is a schematic structural block diagram of an information interaction apparatus 900 according to some embodiments of the present disclosure. The apparatus 900 may be implemented or included in the terminal device 110. The various modules/components in the apparatus 900 may be implemented by hardware, software, firmware, or any combination thereof.

As shown, the apparatus 900 includes a first message presenting module 910 configured to, in response to a predetermined operation associated with a conversation window of a user and a digital assistant, present a first message from the digital assistant in the conversation window. The apparatus 900 further includes a task component element presenting module 920 configured to present, in the first message, an element related to one or more task components, each task component being configured to perform a corresponding function, wherein the task component includes at least one of a plug-in or a scenario.

In some embodiments, the predetermined operation includes an operation of starting a new topic in the conversation window, and the first message presenting module 910 is further configured to: present, in the first message, a task component selection control; or present, in the first message, a task component selection control and prompt information for task component selection.

In some embodiments, the first message presenting module 910 is further configured to present, in the first message, one or more first shortcut instructions recommended, the one or more shortcut instructions being triggerable.

In some embodiments, the task component element presenting module 920 is further configured to: in response to a trigger on the task component selection control, present a task component selection panel, the task component selection panel including at least a list of selectable task components; and in response to a selection of at least one task component in the list, obtain at least one task component selected by the user.

In some embodiments, identification information of the at least one task component selected by the user is presented in the first message or in a third message.

In some embodiments, a task component search area is provided in the task component selection panel for searching a task component.

In some embodiments, the apparatus 900 further includes: a second message presenting module configured to present, in the conversation window, a second message from the digital assistant; and a second shortcut instruction presenting module configured to present, in the second message, one or more second shortcut instructions recommended, the one or more second shortcut instructions being triggerable and suitable for performing a relevant operation by the at least one task component after being triggered.

In some embodiments, the predetermined operation includes receiving, in the conversation window, a user input indicating a predetermined type object, and the first message presenting module 910 is further configured to: present, in the first message, a result of performing a predetermined task with a task component associated with the predetermined type object.

In some embodiments, the predetermined type object includes a portable document format PDF file, and the first message presenting module 910 is further configured to: present, in the first message, summary information of the PDF file generated with a PDF task component.

In some embodiments, the apparatus 900 further includes: a third shortcut instruction presenting module configured to present, in the first message, one or more third shortcut instructions recommended, the one or more third shortcut instructions being triggerable and associated with the predetermined type object.

In some embodiments, the predetermined operation includes: triggering the conversation window via a first application, or receiving a user input in the conversation window triggered via a first application, and the first message presenting module 910 is further configured to perform at least one of: presenting prompt information in the first message, the prompt information indicating a task component selected by default for the first application, or presenting, in the first message, a task component selection control.

In some embodiments, the first message further presents at least one of the following: information about a task performable for the first application, a result of performing a task related to the first application, a shortcut instruction performable for the first application, or a query for a recommendation related to the first application.

In some embodiments, the apparatus 900 further includes a task performing module configured to, in response to a trigger for the shortcut instruction, perform a task corresponding to the shortcut instruction with the task component selected by default.

In some embodiments, the scenario is configured with configuration information, and the configuration information includes at least one of: scenario setting information, or plug-in information, wherein the scenario setting information is configured to describe information related to a corresponding scenario, and the plug-in information indicates at least one plug-in configured to perform a task in the corresponding scenario.

In some embodiments, the first message presenting module 910 is further configured to present, in the first message, an entry control of one or more topics, the one or more topics being historical topics between the user and the digital assistant.

In some embodiments, the message is presented in a form of a message card.

FIG. 10 illustrates a block diagram illustrating an electronic device 1000 in which one or more embodiments of the present disclosure may be implemented. It should be understood that the electronic device 1000 illustrated in FIG. 10 is merely for example and should not constitute any limitation on the functionality and scope of the embodiments described herein. The electronic device 1000 shown in FIG. 10 may be configured to implement the terminal device 110 in FIG. 1.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and capable of performing various processes according to programs stored in the memory 1020. In multiprocessor systems, a plurality of processing units perform computer-executable instructions in parallel to improve parallel processing capabilities of electronic device 1000.

Electronic device 1000 typically includes a plurality of computer storage media. Such media may be any available media accessible to the electronic device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 1030 may be a removable or non-removable medium and may include a machine-readable medium, such as a flash drive, magnetic disk, or any other medium, which may be capable of storing information and/or data and may be accessed within the electronic device 1000.

The electronic device 1000 may further include additional removable/non-removable, volatile/non-volatile storage media. Although not shown in FIG. 10, a disk drive for reading or writing from a removable, nonvolatile magnetic disk (e.g., a ‘floppy disk’) and an optical disk drive for reading or writing from a removable, nonvolatile optical disk may be provided. In these cases, each drive may be connected to a bus (not shown) by one or more data media interfaces. The memory 1020 may include a computer program product 1025 having one or more program modules configured to perform various methods or actions of various embodiments of the present disclosure.

The communication unit 1040 is configured to communicate with a further electronic device through a communication medium. Additionally, the functionality of components of the electronic device 1000 may be implemented in a single computing cluster or a plurality of computing machines capable of communicating over a communication connection. Thus, the electronic device 1000 may operate in a networked environment using logical connections with one or more other servers, network personal computers (PCs), or a further network node.

The input device 1050 may be one or more input devices such as a mouse, a keyboard, a trackball, or the like. The output device 1060 may be one or more output devices, such as a display, a speaker, a printer, or the like. The electronic device 1000 may also communicate with one or more external devices (not shown) through the communication unit 1040 as needed, external devices such as storage devices, display devices, etc., communicate with one or more devices that enable a user to interact with the electronic device 1000, or communicate with any device (e.g., a network card, a modem, etc.) that enables the electronic device 1000 to communicate with one or more other electronic devices. Such communication may be performed via an input/output (I/O) interface (not shown).

According to example implementations of the present disclosure, a computer-readable storage medium having computer-executable instructions stored thereon is provided, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, a special-purpose computer, or other programmable data-processing apparatus so as to produce a machine such that the instructions, when executed through the processing unit of the computer or other programmable data-processing device, produce an apparatus that implements the functions/actions specified in one or more of the blocks in the flowchart and/or block diagram. It is also possible to store these computer-readable program instructions in a computer-readable storage medium that causes the computer, programmable data processing device, and/or other apparatus to function in a particular manner, whereby the computer-readable medium with the instructions stored then includes an article of manufacture including instructions to implement aspects of the function/action specified in the flowchart and/or one or more of the blocks in the block diagram.

Computer-readable program instructions may be loaded onto a computer, other programmable data processing apparatus, or other device such that a series of operational steps are performed on the computer, other programmable data processing apparatus, or other device to produce a computer-implemented process such that the instructions performed on the computer, other programmable data processing apparatus, or other device implement one of the flowchart and/or block diagrams or a plurality of blocks to perform the function/action specified in the flowchart and/or the block diagram.

The flowcharts and block diagrams in the accompanying drawings show the architecture, functionality, and operation of multiple implementations of systems, methods, and computer program products that may be implemented in accordance with the present disclosure. In this regard, each block in the flowcharts or block diagrams may represent a module, program segment, or portion of an instruction, and the module, program segment, or portion of an instruction includes one or more executable instructions for implementing a specified logical function. In some implementations as substitutions, the functions labeled in the blocks may also occur in a different order than those labeled in the accompanying drawings. For example, two consecutive blocks may actually be executed substantially in parallel, and they may sometimes be executed in reverse order, depending on the function involved. It should also be noted that each block in the block diagram and/or flowchart, and combinations of blocks in the block diagram and/or flowchart, may be implemented with a specialized hardware-based system that performs the specified function or action, or may be implemented with a combination of specialized hardware and computer instructions.

Various implementations of the present disclosure have been described above, which are for example, not exhaustive, and are not limited to the implementations disclosed. Many modifications and variations will be apparent to those of ordinary skill in the art without departing from the scope and spirit of the various implementations illustrated. The terminology used herein has been chosen to best explain the principles of the respective implementations, the practical applications or the improvements to the technology in the market, or to enable others of ordinary skill in the art to understand the respective implementations disclosed herein.

What is claimed is:

1. A method of information interaction, comprising:
in response to a predetermined operation associated with a conversation window of a user and a digital assistant, presenting a first message from the digital assistant in the conversation window; and
presenting, in the first message, an element related to one or more task components, each task component being configured to perform a corresponding function;
wherein the task component comprises at least one of a plug-in or a scenario.

2. The method of claim 1, wherein the predetermined operation comprises an operation of starting a new topic in the conversation window, and presenting the element related to one or more task components in the first message comprises:
presenting, in the first message, a task component selection control; or
presenting, in the first message, a task component selection control and prompt information for task component selection.

3. The method of claim 1, further comprising:
presenting, in the first message, one or more first shortcut instructions recommended, the one or more shortcut instructions being triggerable.

4. The method of claim 2, further comprising:
in response to a trigger on the task component selection control, presenting a task component selection panel, the task component selection panel comprising at least a list of selectable task components; and
in response to a selection of at least one task component in the list, obtaining at least one task component selected by the user.

5. The method of claim 4, wherein identification information of the at least one task component selected by the user is presented in the first message or in a third message.

6. The method of claim 4, wherein a task component search area is provided in the task component selection panel for searching a task component.

7. The method of claim 4, further comprising:
presenting, in the conversation window, a second message from the digital assistant; and
presenting, in the second message, one or more second shortcut instructions recommended, the one or more second shortcut instructions being triggerable and suitable for performing a relevant operation by the at least one task component after being triggered.

8. The method of claim 1, wherein the predetermined operation comprises receiving, in the conversation window, a user input indicating a predetermined type object, and presenting, in the first message, the element related to one or more task components comprises:
presenting, in the first message, a result of performing a predetermined task with a task component associated with the predetermined type object.

9. The method of claim 8, wherein the predetermined type object comprises a portable document format PDF file, and presenting the result comprises:
presenting, in the first message, summary information of the PDF file generated with a PDF task component.

10. The method of claim 8, further comprising:
presenting, in the first message, one or more third shortcut instructions recommended, the one or more third shortcut instructions being triggerable and associated with the predetermined type object.

11. The method of claim 1, wherein the predetermined operation comprises:
triggering the conversation window via a first application, or receiving a user input in the conversation window triggered via a first application, and
presenting, in the first message, the element related to one or more task components comprises at least one of:
presenting prompt information in the first message, the prompt information indicating a task component selected by default for the first application, or
presenting, in the first message, a task component selection control.

12. The method of claim 11, wherein the first message further presents at least one of:
information about a task performable for the first application,
a result of performing a task related to the first application,
a shortcut instruction performable for the first application, or
a query for a recommendation related to the first application.

13. The method of claim 11, further comprising:
in response to a trigger for the shortcut instruction, performing a task corresponding to the shortcut instruction with the task component selected by default.

14. The method of claim 1, wherein the scenario is configured with configuration information, and the configuration information comprises at least one of: scenario setting information, or plug-in information, wherein the scenario setting information is configured to describe information related to a corresponding scenario, and the plug-in information indicates at least one plug-in configured to perform a task in the corresponding scenario.

15. The method of claim 1, further comprising:
presenting, in the first message, an entry control of one or more topics, the one or more topics being historical topics between the user and the digital assistant.

16. The method of claim 1, wherein the message is presented in a form of a message card.

17. An electronic device, comprising:
at least one processing unit; and
at least one memory coupled to the at least one processing unit and storing instructions for execution by the at least one processing unit, the instructions, when executed by the at least one processing unit, causing the electronic device to implements operations comprising:
in response to a predetermined operation associated with a conversation window of a user and a digital assistant, presenting a first message from the digital assistant in the conversation window; and
presenting, in the first message, an element related to one or more task components, each task component being configured to perform a corresponding function;
wherein the task component comprises at least one of a plug-in or a scenario.

18. The electronic device of claim 17, wherein the predetermined operation comprises an operation of starting a new topic in the conversation window, and presenting the element related to one or more task components in the first message comprises:
presenting, in the first message, a task component selection control; or
presenting, in the first message, a task component selection control and prompt information for task component selection.

19. The electronic device of claim 17, wherein the operations further comprise:
presenting, in the first message, one or more first shortcut instructions recommended, the one or more shortcut instructions being triggerable.

20. A non-transitory computer-readable storage medium having a computer program stored thereon, the computer program being executable by a processor to implements operations comprising:
in response to a predetermined operation associated with a conversation window of a user and a digital assistant, presenting a first message from the digital assistant in the conversation window; and
presenting, in the first message, an element related to one or more task components, each task component being configured to perform a corresponding function;
wherein the task component comprises at least one of a plug-in or a scenario.
